(19) United States
(12) Patent Application Publication
(10) Pub. No.: US 2002/0192339 A1
(43) Pub. Date: Dec. 19, 2002

(54) Quick cooking pasta

(75) Inventors: Thomas Wilhelm Hauser, Eboli SA (IT); Lorenzo Panattoni, Winterthur (CH)

Correspondence Address: WINSTON & STRAWN, PATENT DEPARTMENT, 1400 L STREET, N.W., WASHINGTON, DC, 20005-3502, US

(73) Assignee: Nestec S.A.

(21) Appl. No.: 10/073,602

(22) Filed: Feb. 11, 2002

Related U.S. Application Data
(63) Continuation of application No. 09/370,226, filed on Aug. 9, 1999, now abandoned.

(51) Int. Cl. A23L 1/16

(52) U.S. Cl. 426/143

(57) ABSTRACT

The invention relates to long, thin, tubular and non-tubular quick cooking pastas, such as lasagna noodles, having a wall thickness of between about 0.60 and 1.6 mm and teeth on at least the inner surface of the tubular pasta and on one or both surfaces of the non-tubular pasta. The teeth may be longitudinal and parallel and preferably extend along the length of the pasta. The teeth have a height of between about 0.3 and 1.6 mm and a height to wall thickness ratio of between about 0.35 and 2.

### CROSS-REFERENCE TO RELATED APPLICATION

This application is a continuation of U.S. application Ser. No. 09/370,226, filed Aug. 9, 1999, now pending, the contents of which are incorporated herein by express reference thereto.

### TECHNICAL FIELD

The present invention relates to long, thin, tubular and non-tubular pastas, including lasagna noodles, which can be cooked in a time on the order of about 5 minutes and which, when cooked, have a shape and a texture in the mouth which are equivalent to those of traditional pastas which require longer cooking time.

### BACKGROUND OF THE INVENTION

Various quick cooking pastas are already known. They generally have a thickness of between 0.3 and 0.6 mm, or alternatively have longitudinal and parallel grooves on their surfaces, which allow the cooking operation to be carried out in a shorter time than that required to carry out the same operation with groove-free products.

European Patent No. 0450428, for example, describes a “spaghetti” which can be cooked in a minimum time of 2 minutes, composed of three lobes forming outer grooves. The lobes are of specific shape and are longitudinal, parallel, and angularly equidistant at 120° intervals.

Similarly, European Patent No. 0557139 describes long, thin and tubular pastas capable of being cooked in perforated sachets in a minimum time of 4 minutes, the cooked pastas do not agglomerate because of the presence of striations on their outer surface. The pasta wall thickness is between 0.4 and 0.6 mm. Furthermore, these striations preferably have a height less than half the thickness of the wall, the height generally being between 0.2 and 0.3 mm. Finally, these striations may also be between 0.5 and 0.85 mm wide, and have a gap separating two adjacent striations which is between 0.5 and 0.85 mm.

Unfortunately, the texture of these cooked tubular pastas in the mouth is soft, or even flaccid, and is not sufficiently reminiscent of the firm consistency of cooked tubular pastas of the same type, that is to say of striation-free pastas. Striation-free pastas, before cooking, have a wall thickness of between 1.1 and 1.6 mm and, once cooked, are of the same appearance on a plate.

Furthermore, these tubular pastas become oval-shaped during their cooking, which is not pleasing to consumers wishing to obtain a pasta of cylindrical appearance, as may be obtained by cooking traditional tubular pastas of the same type, as described above.

The aim of the present invention is to overcome the drawbacks of the prior art.

### SUMMARY OF THE INVENTION

The present invention relates to long, thin, tubular and non-tubular quick cooking pastas, including lasagna noodles. The tubular pasta has, in transverse section, a wall thickness of between about 0.6 and 1.1 mm and teeth on the inner surface of the tube that are longitudinal and parallel with each other. The teeth have a height of between about 0.3 and 2 mm and a height to wall thickness ratio of between about 0.35 and 2. The teeth on the inner surface close up upon cooking to leave only very fine lines on the inner surface of the pasta.

Preferably, the wall thickness of the tubular pasta is less than about 1.05 mm thick, and the teeth are between about 0.3 and 0.9 mm wide and have a gap between two adjacent teeth of between about 0.2 and 0.7 mm.

The non-tubular pasta, or strand of pasta, has a ribbon portion with a first and a second side. The ribbon portion has a wall thickness of between about 0.6 and 1.6 mm and teeth on either one side or on both sides of the strand of pasta. The teeth and the spaces between the adjacent teeth are configured and dimensioned such that the spaces between the teeth close up upon cooking.

Each tooth preferably has a height of between about 0.3 and 1.6 mm with the spacing between adjacent teeth being between about 0.2 and 0.7 mm. The ribbon portion may have a tooth height to pasta wall thickness ratio of between 0.35 and 2.

When teeth are provided on both sides of the ribbon portion, they may be positioned at substantially the same lateral positions on both sides or may be at different lateral positions. The teeth on either side may be evenly spaced across the width of the ribbon portion, arranged parallel to one another, and substantially the same size. The teeth may be oriented parallel to the longitudinal axis of the ribbon portion.

The top portion of the teeth may be flat, convex, or shaped like a nail head. Some of the teeth may be higher than others.

A scalloped portion of pasta may be connected to the ribbon portion of the pasta strand along the side edges thereof. The teeth may extend to cover part of the scalloped portion, on either side thereof. The scalloped portion may have a wall thickness which is the same as the wall thickness of the ribbon portion, or it may have a different wall thickness than that of the ribbon portion.

### BRIEF DESCRIPTION OF THE DRAWINGS

The present invention is illustrated below by the description of the following embodiments, with reference to the attached drawings.

FIG. 1 is a view in perspective, on an enlarged scale, of a tubular pasta according to the invention;

FIG. 2 is a partial view, enlarged 52 times in an optical microscope, of a transverse section of the pasta of FIG. 1;

FIG. 3 is a view in transverse section, on an enlarged scale, of another tubular pasta according to the invention, which has in particular a top portion in the shape of a nail head;

FIG. 4 is a view in transverse section, on an enlarged scale, of another tubular pasta according to the invention, which has teeth of different sizes;

FIG. 5 is a view in transverse section, on an enlarged scale, of another tubular pasta according to the invention which has, in its tubular part, reinforcing spokes;

FIG. 6 is a view in perspective, on an enlarged scale, of one embodiment of a non-tubular pasta according to the invention in the form of a lasagna noodle strand having teeth on one side of the strand;

FIG. 7 is a cross-sectional view of the pasta shown in FIG. 6;

FIG. 8 is an enlarged cross-sectional view of the left side of the embodiment shown in FIG. 7, depicting a cross-section of the scalloped or ruffled portion of the lasagna noodle and a cross-section of a portion of the ribbon portion of the lasagna noodle;

FIG. 9 is an enlarged cross-sectional view of an alternative embodiment of the invention similar to that of FIG. 8 where the scalloped portion of the lasagna strand has a thickness which is equal to that of the ribbon portion;

FIG. 10 is an enlarged cross-sectional view, similar to that of FIG. 8, of another alternative embodiment of the invention where teeth are provided on both sides of the pasta strand and the scalloped portion is thinner than the ribbon portion; and

FIG. 11 is an enlarged cross-sectional view, similar to that of FIG. 9, of yet another alternative embodiment of the invention where teeth are provided on both sides of the pasta strand and the scalloped portion has a thickness equal to that of the ribbon portion.

### DETAILED DESCRIPTION OF THE INVENTION

In this description, the term “traditional pasta” is understood to mean long, thin, tubular or non-tubular pastas, including lasagna noodles, which are generally cooked in 10 to 15 minutes. The pastas may be straight, curved, twisted into a spiral, or scalloped around the edges and have a wall thickness generally between 1.1 and 1.6 mm. With both tubular and non-tubular pastas, the outer surface may be smooth, undulating or scalloped, for example. Among these pastas, it is thus possible to include the various types of traditional tubular pasta, such as (the names are given in Italian) penne, pennette, pennettine, maccheroni, maccheroncelli, mazzani, zite, candele, garganelli, campagnole, cannelli zitoni, cannelli ziti, tagliati di mezzani, canelloni, maniche, bombardoni, rigatoni, cannaroni, rigatti, mezze maniche, ditaloni, ditali di zitone, ditali, avemarie, coralli, cannolichi, denti d'elefante, gigatoni, crestine, gobbetti, chifferi, cimieri and lumache, for example (“Die gute Form” [The Right Shape], M. Götz et al., Museum of Design, Basle, 1991). Non tubular pastas include tagliarini, linguine, trenette, fettuccelle, lasagna ricce, and lasagna lisci, for example.

The advantages of the products according to the present invention, noted during tests which were carried out, are as follows:

Cooking time reduced to 5 minutes according to the traditional method (boiling water), that is to say reduced by more than 50% compared with the time required to cook a traditional pasta having the same dimensions;

The texture of the pasta in the mouth is a firm consistency, highly reminiscent of that of traditional pastas having the same dimensions;

The tubular pasta maintains its cylindrical shape upon being cooked;

The capacity of the pasta to adsorb condiments is greater than that of traditional pastas on account of the presence of teeth;

The appearance of the cooked product on the plate is similar to that of traditional pastas of the same type. Indeed, during cooking, the teeth on the surface of the tubular pasta closes up, leaving only very fine longitudinal lines, which are virtually invisible since they are inside the tube.

The teeth on the non-tubular pasta also close up during cooking to leave only fine longitudinal lines on the surface of the strand of pasta.

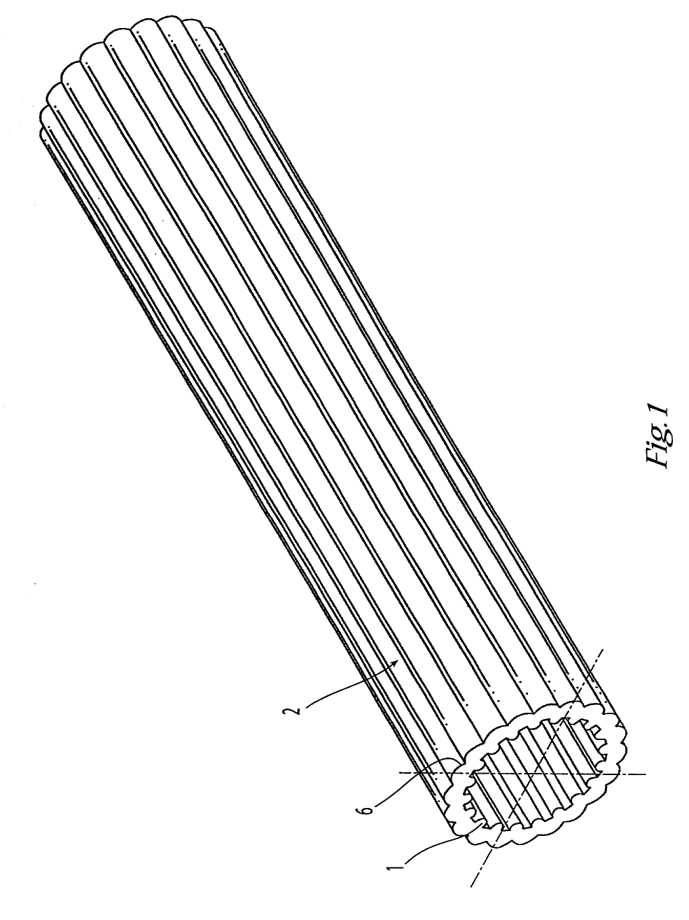

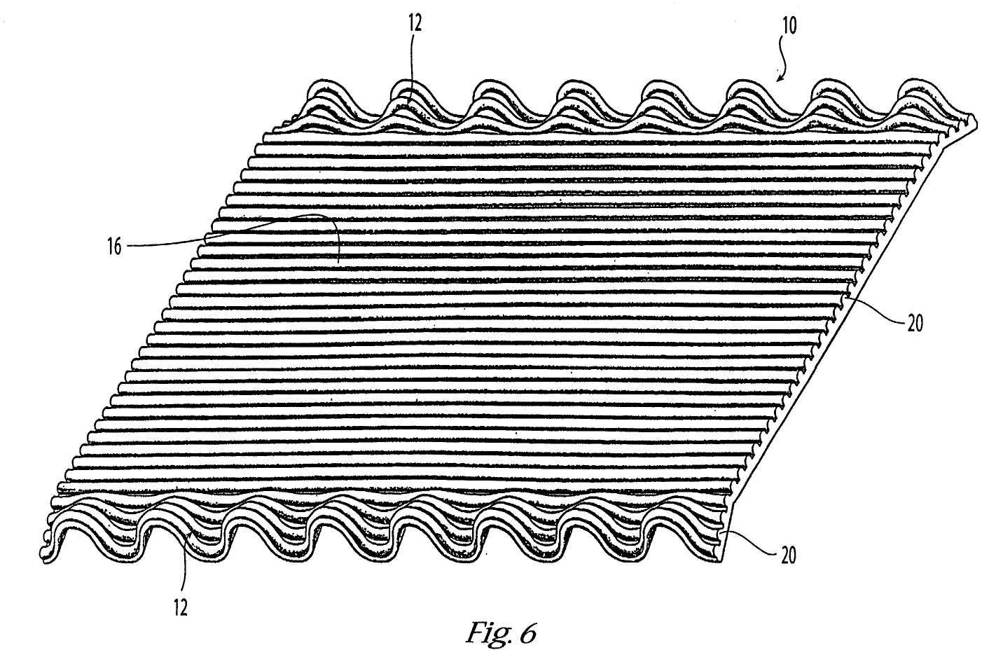

The pastas 2, 10 according to the present invention thus possess teeth 1, 20 on the inner surface of the tube 2 for the tubular variety and on either one or both sides of the strand 10 of pasta for the non-tubular variety, as shown in FIGS. 1 and 6, respectively. The teeth 1, 20 are between about 0.3 and 2 mm in height and have a height to wall thickness ratio of between about 0.35 and 2, preferably 0.4 to 2. It has, indeed, been possible to show that teeth which are too small do not allow a sufficiently acceptable texture in the mouth or a cylindrical appearance of the tubular cooked pasta to be obtained. Furthermore, teeth which are too large tend to be too visible before or after cooking. They also have a tendency to promote development of the oval shape of the cylinder in the tubular pasta, once cooked.

On the other hand, the longitudinal orientation of the teeth 1, 20 is not an important criterion for obtaining a pasta having the advantages described above. Indeed, the teeth 1, 20 may be parallel to the longitudinal axis of the pasta or alternatively may twist around this axis forming spirals. The teeth 1, 20 may also run perpendicular to the longitudinal axis. A spiral of teeth 1 is preferred since, with the tubular pasta 2, when these teeth close up during cooking, they leave internal channels which, on account of their spring-shaped configuration, force the pasta to remain cylindrical.

Furthermore, the tubular pasta 2 according to the invention may have, on its outer surface, undulations 6 which are more or less pronounced, as shown in FIG. 1. However, the wall thickness of the pasta is preferably not less than about 0.6 mm, the thickness being calculated from the internal surface of the pasta tube, disregarding the teeth 1, up to the highest outer surface of the tube.

Similarly, the tubular pasta according to the invention may additionally have, on its outer surface, at least one longitudinal propeller blade, as is the case for the pastas of the “lumache” type mentioned above. In this case also, the wall thickness of the tube is preferably not less than about 0.6 mm, the thickness being calculated from the internal surface of the pasta tube, disregarding the teeth, up to the highest outer surface of the tube, disregarding the propeller blades.

With the non-tubular pasta 10, teeth 20 may be provided on one or both sides of the strand of pasta. A pasta strand having teeth on only one side is depicted in FIG. 6. When teeth 20 are only provided on one side, the other side of the strand may be smooth or may include some form of surface texturing, such as undulations (not shown). The wall thickness 14 of the strands of pasta, as shown in FIG. 8, is preferably not less than 0.6 mm, with the thickness being calculated from one side of the strand to the other, disregarding the height of teeth 20.

In order to obtain a pasta according to the invention having the advantages described above, a pasta may be manufactured having teeth 1, 20 on any of the surfaces thereof. The base of each tooth, that is to say the lower part of each tooth, preferably has a height of about 0.2 to 0.8 mm from the surface of the pasta. Each tooth may have a parallelepipedal or frustoconical contour with substantially flat or even convex and/or concave walls. The width of the base of the teeth is preferably between about 0.3 and 0.9 mm.

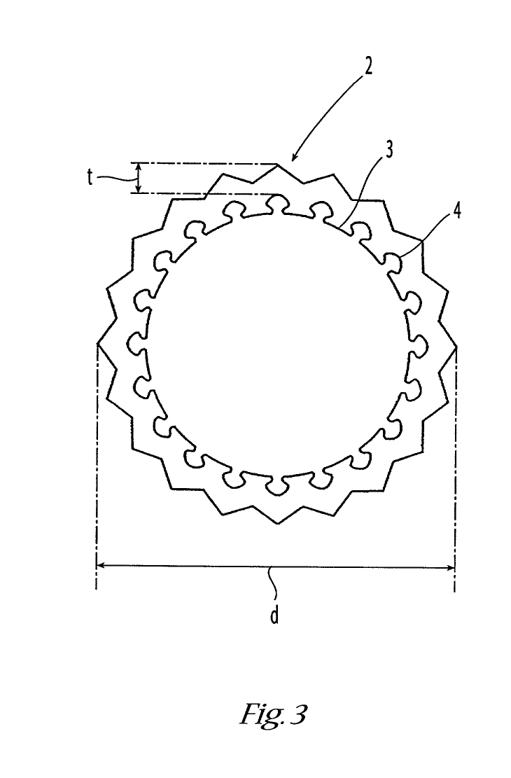

On the other hand, the top portion of the teeth, that is to say the part above the base of each tooth, may be of any imaginable shape, that is to say that it may be square, rectangular, triangular, convex, or in the shape of a nail head. The width of the top portion of each tooth is preferably between about 0.3 and 0.9 mm, and shapes which lead to optimum closing of the space between the teeth after cooking are chosen. In particular, a top portion in the shape of a nail head 3 may be used, as shown in FIG. 3, this having the advantage of further increasing the surface area of the pasta which is accessible to water.

Finally, with tubular pasta 2, the inner surface of the cylinder separating two adjacent teeth may be substantially flat or alternatively may have a radius of curvature substantially equal to that of a traditional pasta of the same diameter, with the diameter being calculated from the inner surface of the tube. However, it is also possible to accentuate the curvature of this surface and thus to make it concave or even triangular, with a depth of between about 0.2 and 0.4 mm, for example. (See FIG. 3, for example). The wall thickness between two adjacent teeth is preferably not less than 0.6 mm.

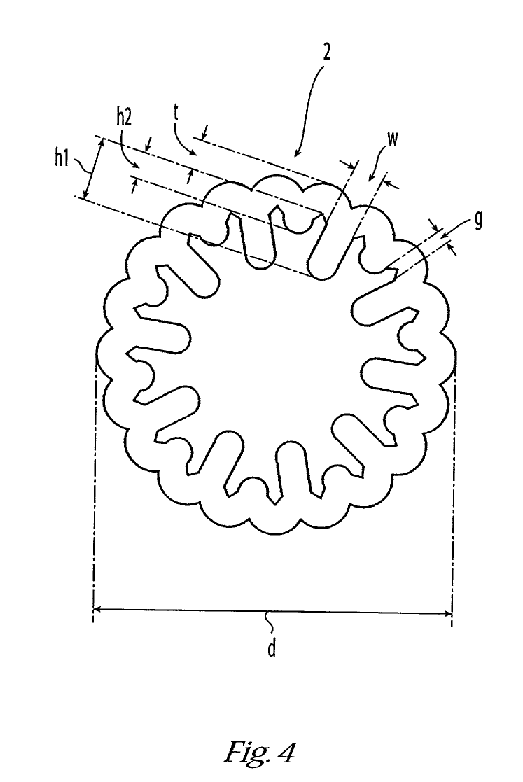

In order to obtain a pasta according to the invention having the advantages described above, and in particular a very firm texture in the mouth, it is also possible to manufacture pastas as described above having teeth which, taking every other one, are at least 1.5 times higher than the height of the other teeth. An example of this on the interior of a tubular pasta is shown in FIG. 4. These type of teeth may also be utilized on non-tubular pasta.

The volume of the pasta is thus increased proportionally with its surface area and hence also the thickness of the cooked pasta, without, however, increasing its cooking time or neglecting optimum closing of the teeth after cooking. This pasta may thus cook in a time of the order of about 5 minutes, the cooked product remaining substantially cylindrical in the case of tubular pasta, and the texture of the pasta in the mouth may also be improved in comparison with previously known quick cooking pasta products.

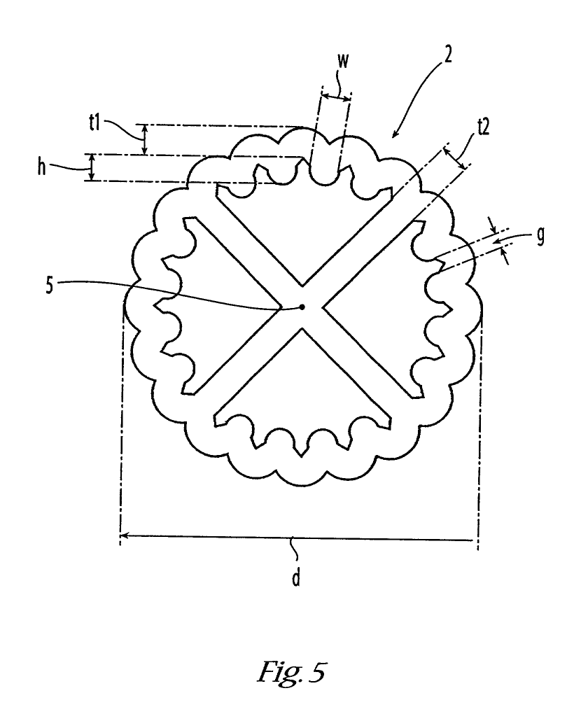

In order to obtain a pasta according to the invention having the advantages described above, and in particular having cylinder rigidity once cooked, it is possible to manufacture pastas according to the invention having the characteristics described above and additionally having, in their tubular part, a central spindle 5 connected to the inner wall by at least three spokes which are longitudinal with respect to the spindle, as depicted in FIG. 5, for example.

The thickness of the walls of the spokes may be between about 0.6 and 1.1 mm, the spindle may have a diameter of between about 0.6 and 1.1 mm, and the spokes may be parallel to the spindle of the pasta or alternatively may rotate relative to this spindle. Parallel and equiangular spokes are preferably produced, which thus reinforce the rigidity of the cooked product.

In addition, these spokes 5 afford another advantage for tubular pastas greater than 10 mm in diameter. Indeed, whether they are traditional slow cooking or according to the invention, the tubular pastas greater than 10 mm, especially greater than 15 mm, in diameter tend to flatten out on the plate under their own weight, and may thus again give an impression of developing an oval shape. On the other hand, when they have the spokes described above, the tubular pastas according to the invention appear perfectly round on the plate, regardless of their diameter.

The diameter of the tubular pastas according to the invention is thus preferably between about 6 and 30 mm, the diameter being calculated from the outer surface of the pastas.

Finally, the pastas according to the present invention may be manufactured by production means already known to those skilled in the art. They may be marketed within the ranges of long, thin and tubular pastas having a smooth or undulating outer wall, which pastas may or may not be filled, and especially the products already described above. They may also be marketed within the ranges of long, thin, non-tubular pastas, such as lasagna noodles.

In particular, in order to manufacture the pastas according to the present invention, wheat flour, especially from the species Triticum durum or Triticum aestivum, is mixed with water up to a water content of about 25-35%, in a standard mixer, for example. The mixture may then be kneaded for about 10 to 15 minutes at a temperature of about 30 to 35° C. Preferably, in the last 5 to 8 minutes of the kneading, the absolute air pressure in the mixer is reduced by vacuum suction to about 30 to 130 millibar, so as to remove air bubbles from the mixture.

The cereal dough may then be introduced into a single-screw extruder, for example, and the dough may be extruded at a pressure of about 85 to 150 bar, while cooling the body of the extruder with water so that the temperature of the dough does not exceed about 45 to 55° C., for example. A knife placed at the outlet of the die can then cut the extruded pasta into pieces of pasta between about 0.50 cm and 20 cm or more in length, for example.

The pastas according to the invention obtain their shape by means of die inserts which have an orifice of similar configuration to that of the pastas according to the invention, in particular a configuration which is slightly larger on account of the shrinkage of the pastas when they are dried as described below, for example.

Indeed, the pieces of pasta may then be dried in a conventional manner until they have a water content of between about 3 and 13%, but preferably 5 to 12%, for example. It is then preferred to cool the dried pastas, having a temperature of the order of about 60 to 82° C., on leaving the drying device, to an ambient temperature on the order of 25° C., and then to package them in plastic bags.

### EXAMPLES

### Example 1

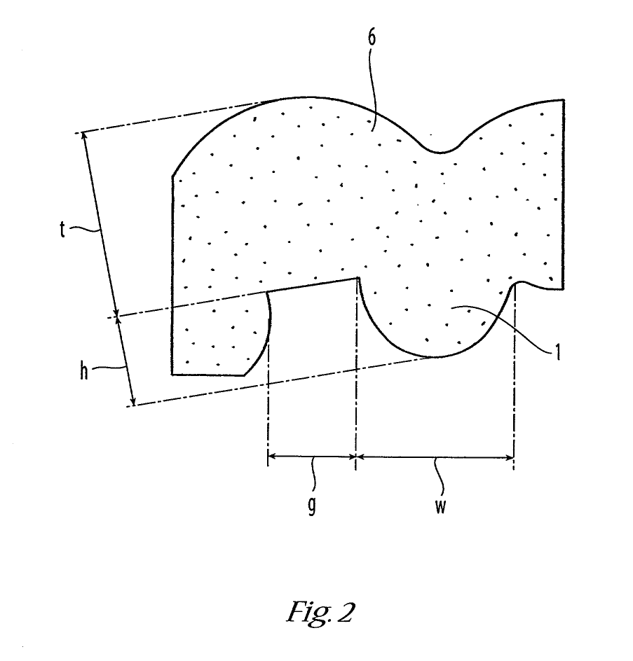

The same pastas as that illustrated in FIGS. 1 and 2 are prepared by production means known to those skilled in the art.

As may be seen in FIG. 1, these tubular pastas 2 comprise inner teeth “1” extending longitudinally and parallel to their axis, and outer undulations “6” characteristic of penne-type pastas, in particular of “penne rigate”.

Furthermore, as described in FIG. 2, the average wall thickness “t” is 1.05 mm, each tooth has an average height “h” of 0.45 mm, an average width “w” of 0.70 mm and an average gap “g” between two adjacent teeth of 0.49 mm. Finally, the diameter of these pastas is about 8.9 mm and they are about 50 mm in length.

For comparison, traditional slow cooking pastas having no inner teeth are prepared, and having the same outer undulations, a wall thickness of 1.3 mm, a diameter of 8.9 mm and a length of 50 mm. Such a pasta cooks under the conditions described below in 10 minutes.

For comparison, a quick cooking pasta is also prepared having no inner teeth or even outer undulations, and having a wall thickness of 0.5 mm, a diameter of 8.9 mm and a length of 50 mm.

These three types of pasta are cooked in fully boiling water with addition of 10 g/l of salt, until an inner white ring of ungelatinized starch is still seen in the wall, with the naked eye.

The firmness of the above cooked pastas is then determined, at a temperature of 65° C., using a Stevens texture analyser (LFRA model) fitted with a TA7 cutting device (Rheovisco A. G., Switzerland) which is driven at a rate of 0.2 mm/s, and using an Instron (model 1011) equipped with a Kramer cell which is driven at a cut/shear rate of 500 mm/minute. The results, expressed in newtons, are illustrated in the table below.

| | Stevens Machine | Instron machine |
|---|---|---|
| Pastas | (N) | (N) |
| According to the invention | 3.73 | 815 |
| Slow cooking traditional | 4.08 | 982 |
| Quick cooking traditional | 1.86 | 433 |

As may be seen in the above table, the pastas according to the invention have a firmness which is markedly similar to slow cooking traditional pastas.

The cooking times of the pastas of the invention and of the quick cooking traditional pastas, as well as the assessment of their texture in the mouth and of their cylindrical appearance by a group of individuals, are illustrated in the table of Example 4 below.

### Example 2

The same pastas as those illustrated in FIG. 3 are prepared by production means known to those skilled in the art. These pastas have a thickness “t” of about 0.7 mm, and inner teeth longitudinal and parallel to the axis, having a top portion “3” in the shape of a nail head, and a surface “4” separating two adjacent teeth which is concave. The diameter “d” of these pastas is about 8.7 mm and their length is about 50 mm.

For comparison, slow cooking traditional pastas without inner teeth are prepared, having the same outer undulations, a wall thickness of 1.3 mm, a diameter of 8.7 mm and a length of50 mm.

The two types of pasta as described in Example 1 are cooked. The slow cooking traditional pastas cook in 10 mm. The cooking time of the pastas of the invention, as well as the assessment of their texture in the mouth and of their cylindrical appearance by a group of individuals, are illustrated in the table of Example 4 below.

### Example 3

The same pastas as those illustrated in FIG. 4 are prepared by production means known to those skilled in the art. As may be seen, these pastas comprise teeth longitudinal and parallel to the longitudinal axis of the pasta which, taking every other one, have a height “h1” of about 1.55 mm, whereas the other teeth have a height “h2” of about 0.65 mm. The width “w” of the teeth is about 0.72 mm, the gap “g” between two adjacent teeth is about 0.36 mm, the wall thickness “t” is about 0.72 mm, its diameter “d” is about 8.7 mm and the total length of the pasta is about 50 mm.

For comparison, traditional pastas without teeth are prepared, having the same outer undulations, a wall thickness of 1.3 mm, a diameter of 8.7 mm and a length of 50 mm.

The two types of pasta are cooked as described in Example 1. The slow cooking traditional pastas cook in 10 minutes. The cooking time of the pastas of the invention, as well as the assessment of their texture in the mouth and of their cylindrical appearance by a group of individuals, are illustrated in the table of Example 4 below.

### Example 4

The same pastas as those illustrated in FIG. 5 are prepared by production means known to those skilled in the art. The wall thickness “t1” is about 0.72 mm, each tooth longitudinal and parallel to the axis of the pasta has a height “h” of about 0.66 mm, a width “w” of about 0.72 mm and a gap “g” between two adjacent teeth of about 0.35 mm. These pastas also have a spindle “5” bearing 4 spokes which are substantially flat, longitudinal with respect to the axis of the pasta and equiangular at 90° C., with a wall thickness “t2” of about 0.72 mm. Finally, the diameter “d” of the pasta is about 8.7 mm and its total length is about 50 mm.

For comparison, traditional pastas without teeth or inner spokes are prepared, having the same outer undulations, a wall thickness of 1.3 mm, a diameter of 8.7 mm and a length of 50 mm.

The two types of pasta are cooked as described in Example 1, and the quality of the texture in the mouth, of the firmness and of the cylindrical appearance of these pastas are then tested by the means described below.

The texture in the mouth and the cylindrical shape of the pasta of the invention were assessed by a tasting and visual test involving about thirty individuals. The values are given as a percentage of individuals who found the pastas according to the invention to be similar to those of the corresponding comparative example (slow cooking traditional pasta).

Similarly, the same test of comparison is carried out between the two cooked pastas, the quick cooking pasta and the slow cooking pasta, which are described in the comparative examples of the pasta of Example 1. The values are given as a percentage of individuals who found the traditional quick cooking pastas to be similar to the slow cooking traditional pastas.

The results of the various tests carried out on the pastas of Examples 1 to 4, as well as their cooking time, are illustrated in the table below.

| | Texture in | | |
|---|---|---|---|
| Pasta according to the | the mouth | Cylindrical Shape | Cooking time |
| invention | (%) | (%) | (min) |
| Example 1 | 65 | 86 | 5 |
| Example 2 | 63 | 87 | 5 |
| Example 3 | 75 | 75 | 5 |
| Example 4 | 20 | 90 | 5 |
| Quick cooking traditional | 8 | 11 | 4 |
| pasta of Example 1 | | | |

Referring to FIGS. 6-11, a non-tubular pasta 10 is shown in the form of a lasagna noodle. The lasagna noodle has an interior ribbon portion 16, which is substantially flat, and scalloping or ruffles 12 along its outer edges. The scalloping may be provided on one or both side edges of the ribbon portion 16. A plurality of teeth 20 are provided on one side of the noodle and the other side of the noodle is substantially smooth. It should be noted that the type of noodle depicted herein is for illustration purposes only. The present invention is contemplated to be useful for any type of noodle. However, the following description will focus on the specific features of the embodiment of FIG. 6, keeping in mind that many of these features are applicable to other types of pastas as well.

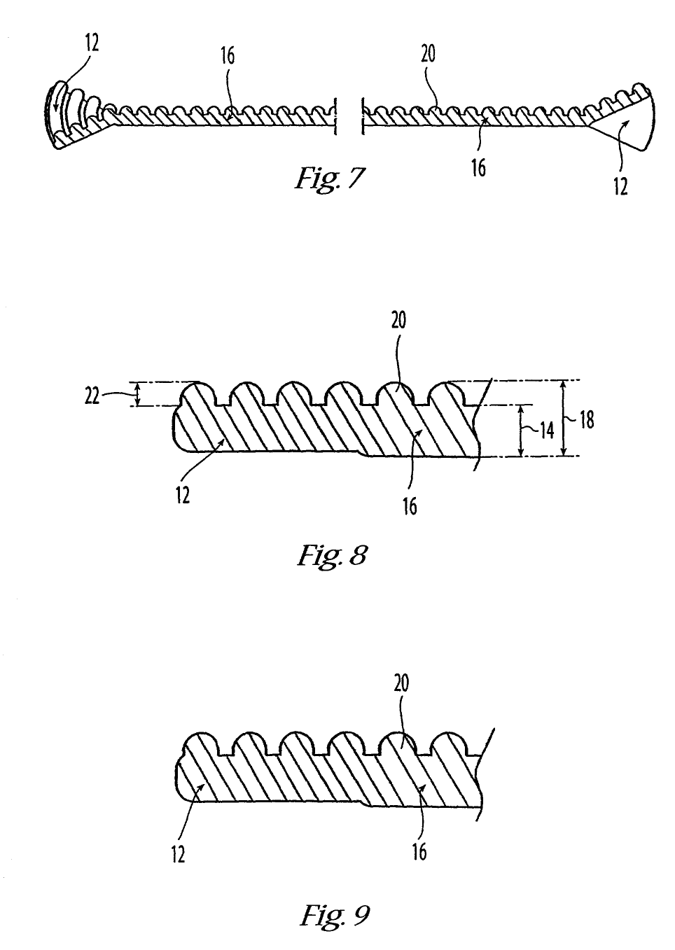

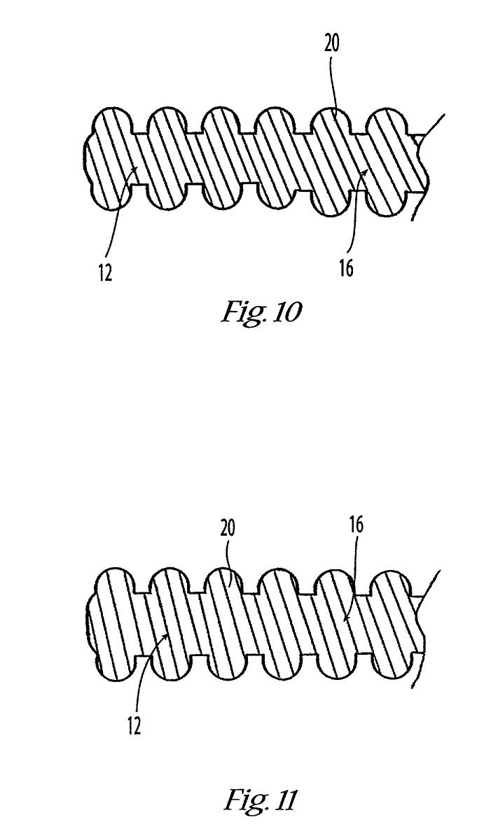

As shown in FIGS. 6 and 7, teeth 20 preferably run parallel to one another along the entire length of the strand of pasta. The teeth 20 are preferably aligned parallel to the longitudinal axis of the noodle. Teeth 20 are spaced and configured and dimensioned so that, upon cooking, the gaps between the teeth are closed to leave only very fine lines on the surface of the pasta. These lines are preferably nearly invisible to the eye. Teeth 20 may preferably also be provided on the scalloped edges 12. The wall thickness 14 of noodle 10 is shown in FIG. 8 as the thickness of the strand of pasta excluding tooth 20 height. Thickness 14 may be constant throughout the width and length of the pasta or may vary. FIGS. 8 and 10 show the scalloped portion 12 of the lasagna noodle as being thinner than the ribbon portion 16 of the noodle. FIGS. 9 and 11 show the scalloped portion as being the same thickness as the ribbon portion 16.

The wall thickness 14 may range from about 0.6 to 1.6 mm. In a preferred embodiment, the ribbon portion 16 has a thickness of 1 mm and the scalloped portion has a thickness of 0.9 mm. The total thickness 18 of the noodle in the embodiment shown in FIG. 8 is 1.45 mm, which includes the height of teeth 20 and wall thickness 14.

Teeth 20 are preferably between about 0.3 and 2 mm in height and have a height to wall thickness ratio of between about 0.35 and 2. The width of the base of teeth 20 is preferably between about 0.3 and 0.9 mm. Each tooth may have a parallelepipedal or frustoconical contour with flat or even convex and/or concave walls. In a preferred embodiment, the teeth have a round profile with a tooth height 22 of about 0.45 mm, as depicted in FIG. 8.

FIG. 9 depicts an embodiment of the invention where scalloped portion 12 has a wall thickness 14 equal to the wall thickness 14 of ribbon portion 16, with teeth 20 being disposed on only one side of the pasta strand.

FIGS. 10 and 11 depict embodiments of the invention where teeth 20 are provided on both sides of the strand pasta. The teeth may be evenly spaced and positioned at equal transverse locations across the width of the strand of pasta in “mirror image” form, as shown in FIGS. 10 and 11, or they may be offset on either side of the strand such that the teeth alternate in position along the width of the strand of pasta (not shown). In addition, the scalloped portion 12 may have a thinner wall thickness than the ribbon portion 16, as shown in FIG. 10. The scalloped portion 12 may also be of the same wall thickness as ribbon portion 16, as shown in FIG. 11. Alternatively, scalloped portion 12 may have a wall thickness 14 which is greater than the wall thickness of ribbon portion 16 (not shown).

Other embodiments are also contemplated. For instance, it is not essential that teeth 20 be evenly spaced or parallel to one another. Teeth 20 may be formed on a portion of the noodle strand and not present on other portions. As discussed above, teeth 20 may have a variety of shapes and sizes. In addition, the side of the strand to which teeth 20 are connected is depicted in FIGS. 6-11 as being substantially flat. It may be desired to utilize a non-flat surface, such as an undulating, convex, concave, or other shaped surface.

It should be understood that variations and modifications within the spirit and scope of the invention may occur to those skilled in the art to which the invention pertains. Accordingly, any expedient modifications readily attainable by one versed in the art from the disclosure set forth herein that are within the scope and spirit of the present invention are to be included as further embodiments of the present invention.

What is claimed is:

1. A quick cooking lasagna noodle comprising a ribbon portion having a first side and a second side, the ribbon portion having a variable wall thickness of about 0.6 mm to 1.6 mm, and including a plurality of spaced teeth extending along the length of at least one side thereon, with each tooth having a height of 0.3 mm to 1.6 mm and the spacing between adjacent teeth being about 0.2 mm to 0.7 mm, the ribbon portion having a tooth height to pasta wall thickness ratio of 0.35 to 2;
wherein the wall thickness of the pasta does not include the height of the teeth, and wherein the teeth and spaces between adjacent teeth are configured and dimensioned such that the spaces between adjacent teeth close upon cooking to provide virtually invisible lines on the surface of the cooked pasta; and
wherein the ribbon portion includes two side edges where the first and second sides meet, and a scalloped portion is connected to the ribbon portion along at least one of the first or second edges thereof, with each scalloped portion having a first side and a second side and with the teeth oriented parallel to a longitudinal axis of the ribbon portion.

2. The lasagna noodle of claim 1, wherein the teeth are about 0.3 mm to 0.9 mm wide and have a gap between adjacent teeth of about 0.3 mm to 0.7 mm.

3. The lasagna noodle of claim 1, wherein the teeth have a height to wall thickness ratio of about 0.4 to 2.

4. The lasagna noodle of claim 1, wherein the plurality of teeth are provided on both sides of the ribbon portion.

5. The lasagna noodle of claim 4, wherein the plurality of teeth on the first side of the ribbon portion are positioned at substantially the same lateral positions as the plurality of teeth on the second side of the ribbon portion, such that the teeth on either side of the ribbon portion form a mirror-image of one another.

6. The lasagna noodle of claim 4, wherein the plurality of teeth on the first side of the ribbon portion are positioned at different lateral positions than the plurality of teeth on the second side of the ribbon portion.

7. The lasagna noodle of claim 1, wherein the plurality of teeth are evenly spaced across the width of the ribbon portion, are arranged parallel to one another, and are substantially the same size.

8. The lasagna noodle of claim 1, wherein the top portion of the teeth is substantially flat, convex, or in the shape of a nail head.

9. The lasagna noodle of claim 1, wherein some of the teeth have a greater height than other teeth.

10. The lasagna noodle of claim 1, wherein the teeth are oriented parallel to a longitudinal axis of the ribbon portion.

11. The lasagna noodle of claim 1, wherein the plurality of teeth extend to cover at least part of the scalloped portion.

12. The lasagna noodle of claim 11, wherein the plurality of teeth extend to cover at least part of the scalloped portion of the same side as the teeth are positioned on the ribbon portion.

13. The lasagna noodle of claim 1, wherein the scalloped portion has a wall thickness equal to or smaller than the wall thickness of the ribbon portion.

14. The lasagna noodle of claim 11, wherein the teeth on the scalloped portion are the same size and spacing as the teeth on the ribbon portion.

15. The lasagna noodle of claim 1, wherein the plurality of teeth are positioned on both the first and second sides of the ribbon portion and on both the first and second sides of the scalloped portion.

16. A quick cooking lasagna noodle comprising a ribbon portion having a first side and a second side, the ribbon portion having a wall thickness of about 0.6 mm to 1.6 mm, and including a plurality of spaced teeth extending along the length of only one side thereon, the other side being substantially smooth, with each tooth having a height of 0.3 mm to 1.6 mm and the spacing between adjacent teeth being about 0.2 mm to 0.7 mm, the ribbon portion having a tooth height to pasta wall thickness ratio of 0.35 to 2 wherein the wall thickness of the pasta does not include the height of the teeth, and wherein the teeth and spaces between adjacent teeth are configured and dimensioned such that the spaces between adjacent teeth close upon cooking to provide virtually invisible lines on the surface of the cooked pasta.

17. The lasagna noodle of claim 16, wherein the ribbon portion includes two side edges where the first and second sides meet, and a scalloped portion is connected to the ribbon portion along at least one of the first or second side edges thereof, with each scalloped portion having a first side and a second side, the teeth are oriented parallel to a longitudinal axis of the ribbon portion.

18. A quick cooking lasagna noodle comprising a ribbon portion having a first side and a second side, the ribbon portion having a wall thickness of between about 0.6 and 1.6 mm, and including a plurality of spaced teeth extending along the length of a least one side thereon, with each tooth having a height of 0.3 mm to 1.6 mm and the spacing between adjacent teeth being about 0.2 mm to 0.7 mm, the ribbon portion having a tooth height to pasta wall thickness ratio of 0.35 to 2 wherein the wall thickness of the pasta does not include the height of the teeth, and wherein the teeth and spaces between adjacent teeth are configured and dimensioned such that the top portion of the teeth is substantially convex or in the shape of a nail head and the spaces between adjacent teeth close upon cooking to provide virtually invisible lines on the surface of the cooked pasta.

19. The lasagna noodle of claim 18, wherein the ribbon portion includes two side edges where the first and second sides meet, and a scalloped portion is connected to the ribbon portion along at least one of the first or second side edges thereof, with each scalloped portion having a first side and a second side, the teeth are oriented parallel to a longitudinal axis of the ribbon portion.
